(19) United States
(12) Patent Application Publication
(10) Pub. No.: US 2002/0087950 A1
(43) Pub. Date: Jul. 4, 2002

(54) Capturing snapshots of a debuggee's state during a debug session

(75) Inventors: Denis F. Brodeur, Markham (CA); Tim A. Fors, Toronto (CA)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 09/963,085

(22) Filed: Sep. 25, 2001

(30) Foreign Application Priority Data
Sep. 27, 2000 (CA) 2,321,019

(51) Int. Cl. G06F 9/44

(52) U.S. Cl. 717/124

(57) ABSTRACT

Methods, systems and computer program products are provided for capturing snapshots of a debuggee's state during a debug session. More particularly, this invention relates to capturing state and debug data of a debuggee at intervals during a debug session and allowing a software developer to view and/or annotate the captured state and debug data in a developer preferred manner.

### FIELD OF THE INVENTION

This invention relates to capturing snapshots of a debuggee's state during a debug session. More particularly, this invention relates to capturing state and debug data of a debuggee at intervals during a debug session and allowing a software developer to review the captured state and debug data in a developer preferred manner.

### BACKGROUND OF THE INVENTION

As part of the development of software applications, software developers frequently must “debug” their code to ensure that it operates properly and without interruption. There are numerous debugging methods and techniques available to developers, such as special debugging application programming interfaces and breakpoint mechanisms. To aid software developers, debugging software programs or debuggers have been created to automate such debugging methods and techniques. Debuggers can be stand-alone or integrated into another software application such as an object-oriented application development environment.

Debuggers typically only show the developer in a user interface (UI) the current state and associated debug data of a software program being debugged (also known as a debuggee). As soon as the debuggee is allowed to run, or is modified in any other way, the previous state and debug data of the debuggee is “lost”. In other words, the debugging information presented to the software developer via the debugger UI is modified, and hence “lost” to the software developer, when the debuggee is modified and/or runs. While the current state and debug data of the debuggee presented to the software developer by the debugger is obviously of immediate importance, it is often useful to re-examine the state and the debug data of the debuggee as it existed earlier in a debugging session of the debuggee. For example, it would be beneficial for a software developer to view various items of information pertaining to the debuggee such as previous stack information, past contents of registers or storage, or values of variables, for example, prior to a last “step” command in the debugger.

Accordingly, it is not uncommon for a software developer to restart in a debugger a debug session with respect to the debuggee and retrace his/her steps (as best as possible) in order to simply see what the state and debug data of the debuggee was at a previous point in its execution. It is also not uncommon for a software developer to manually capture this state and debug information by writing down the values of variables, contents of registers, etc. throughout the debug session. Both of these approaches are extremely time-consuming, tedious, and error prone.

Developers also may make use of two other debugging mechanisms, namely core dumps and process logs, when debugging programs.

A core dump is a record of the memory contents of the execution of a program that is usually (if not exclusively) captured when an exception occurs during the normal execution of the program (i.e. not while debugging the program) and then may be subsequently examined using a debugger to determine where and why the exception occurred. The core dump contains a (possibly) complete image of the program's entire storage contents at the time an exception occurred or upon completion of execution and thus allows for the examination of the information of a previous invocation of a program. Consequently, a core dump does not reflect the current state and debug data of any executing process at any arbitrary point in time but rather is strictly a single “static” view of a program's state typically on the occurrence of an exception or at the end of execution.

Core dumps are primarily used for “post-mortem” debugging. Much of a debugger's normal functional interaction with a debuggee such as stepping or running the debuggee are not available or evident. Further, a core dump can be very expensive in terms of memory and processor usage since it typically contains a full image of a program's storage contents and software developer has limited ability to control what is “dumped”. Lastly, the ability to take a core dump will vary from platform to platform and, on some platforms, may not be available at all.

Another debugging mechanism is a process log. A process log, typically provided by a debugger, is essentially an audit trail of all major events in chronological order that have taken place in the debuggee process during the debug session. For example, when a module is loaded into the debuggee process, the process log would contain an entry to capture this event. Similarly, when another module is loaded into the debuggee process thereafter, a subsequent entry in the log would indicate the occurrence of that event.

To determine the state and debug data of a debuggee at any point during its execution, the software developer would have to manually examine the debuggee's process log and piece together the debuggee state and debug data by looking at what changes had taken place from one point of execution to another. For example, although a process log might indicate to the developer that certain modules were loaded into the process and/or unloaded from the process as a result of running from point A to point B, there is no convenient way for the developer to know the net effect of all the loads and unloads, i.e., exactly which modules were active in the process at point B. Manually trying to piece together this information by examining the process log might be an onerous task, particularly if i) the process log contains a lot of “noise,” or information that is not strictly related to the loading and unloading of modules; ii) many modules were loaded and unloaded while running from point A to point B; and/or iii) some of the same modules that were loaded were also unloaded while running from point A to point B (and perhaps several times). Accordingly, it would be advantageous to be able to review the state and debug data of a debuggee as it existed earlier during a given debug session. It also would be advantageous to capture “snapshots” of the debuggee's state and debug data, a snapshot of a debuggee's state and debug data being a record of the debug information relating to the debuggee. Such snapshots would preferably be persisted (e.g. in a file) so that advantageously the snapshots of the debuggee's state and debug data can be examined subsequent to a debug session in which they were captured. Moreover, it would be advantageous to provide the developer the ability to capture, view, and annotate debuggee state and debug information captured as snapshots as described above.

Thus, it is desirable to provide a method, system and computer program product for capturing snapshots of a debuggee's state and debug data during a debug session that overcomes the foregoing and other disadvantages.

### SUMMARY OF THE INVENTION

Accordingly, there is provided a computer-implemented method for capturing one or more snapshots of a debuggee's state and debug data comprising the step of, at one or more points during a debug session of the debuggee, capturing information used to create a user interface of a debugger representing the debuggee's state and debug data as a snapshot for later usage. The above method may be further provided wherein the debugger comprises objects corresponding to elements of the debuggee and which comprise the debuggee's state and debug data and wherein the step of capturing information as a snapshot comprises serializing the objects. The above methods may further be provided wherein the step of capturing information as a snapshot is executed selectively based upon user input. The above methods may further comprise the step of annotating one or more snapshots with a comment. Further, the above methods may comprise the step of viewing one or more snapshots through a user interface. The step of viewing may also comprise replaying one or more snapshots in the user interface by presenting a selected snapshot through the user interface and, if there are two or more snapshots, moving forward and backward through the snapshots and simultaneously presenting those snapshots through the user interface. And, an above method may comprise the step of viewing one or more snapshots through a user interface by deserializing the objects. Further, certain above methods may be provided wherein only objects that contain state and debug information presented through the user interface of the debugger are serialized. Also, the above methods may be performed in a debugger.

There is also provided a method for capturing a snapshot of a debuggee's state and debug data from a debugger, the debugger comprising objects containing the debuggee's state and debug data comprising the step of, during a debug session of the debuggee, capturing information used to create a debugger user interface representing the debuggee's state and debug data as the snapshot for later usage by serializing the objects.

Further, there is provided a program storage device, tangibly embodying computer readable program code, for causing a computer to perform the method steps of any one of the above methods.

Also provided is a computer program product for capturing one or more snapshots of a debuggee's state and debug data, the computer program product comprising computer readable code means to, at one or more points during a debug session of the debuggee, capture information used to create a user interface of a debugger representing the debuggee's state and debug data as a snapshot for later usage. The above computer program product may also be provided wherein the debugger comprises objects corresponding to elements of the debuggee and which comprise the debuggee's state and debug data and wherein computer readable program means to capture information as a snapshot comprises computer readable program means to serialize the objects. The above computer program products may also be provided wherein computer readable program means to capture information as a snapshot is executed selectively based upon user input. Moreover, the above computer program products may further comprise computer readable program means to annotate one or more snapshots with a comment. Also, the computer program products above may further comprise computer readable program means to view one or more snapshots through a user interface. Also, computer readable program means to view may be provided comprising computer readable program means to replay one or more snapshots in the user interface by presenting a selected snapshot through the user interface and, if there are two or more snapshots, moving forward and backward through the snapshots and simultaneously presenting those snapshots through the user interface. The above computer program product may further comprise computer readable program means to view one or more snapshots through a user interface by deserializing the objects. And, the above computer program products may be incorporated into a debugger.

A computer program product for capturing a snapshot of a debuggee's state and debug data from a debugger, the debugger comprising objects containing the debuggee's state and debug data is also provided comprising a snapshot manager to, during a debug session of the debuggee, capture information used to create a debugger user interface representing the debuggee's state and debug data as the snapshot for later usage by serializing the objects.

There is also provided a computer program product for capturing one or more snapshots of a debuggee's state and debug data, the computer program product comprising computer readable code means to, at one or more points during a debug session of the debuggee, capture information used to create a user interface of a debugger representing the debuggee's state and debug data as a snapshot for later usage.

Additionally, there is provided a computer system for capturing snapshots of a debuggee's state and debug data comprising a means to, at one or more points during a debug session of the debuggee, capture information used to create a user interface of a debugger representing the debuggee's state and debug data as a snapshot for later usage.

Furthermore, there is provided a computer system for capturing one or more snapshots of a debuggee's state and debug data, the computer system comprising a snapshot manager to, at one or more points during a debug session of the debuggee, capture information used to create a user interface of a debugger representing the debuggee's state and debug data as a snapshot for later usage.

### BRIEF DESCRIPTION OF THE DRAWINGS

The present invention is illustrated by way of example and not limitation in the figures of the accompanying drawings in which like references indicate similar or corresponding elements and in which:

FIG. 1 is a block diagram of a computer workstation environment in which the present invention may be practiced;

FIG. 2 is a block diagram of the model-view-controller structure of the debugger incorporating the snapshot tool of the preferred embodiment of the invention;

FIG. 3 is a block diagram depicting the possible interconnections between multiple clients and multiple debug engines/debuggees with the model of FIG. 2;

FIG. 4 is a block diagram of the model-view-controller structure of the debugger incorporating the snapshot tool of Figure wherein the model objects have been serialized to form a snapshot;

FIG. 5 is a chart which illustrates snapshot tool features used to operate the snapshot tool that are presented to the developer through the snapshot tool UI of the preferred embodiment of the present invention;

FIG. 6 is a chart which illustrates further detail of the snapshot capturing feature shown in FIG. 5 of the preferred embodiment of the present invention;

FIG. 7 is a chart which illustrates further detail of the snapshot viewing feature shown in FIG. 5 of the preferred embodiment of the present invention; and

FIG. 8 is a chart which illustrates further detail of the snapshot annotating feature shown in FIG. 5 of the preferred embodiment of the present invention.

FIGS. 9 to 11 are screenshots of a user interface of a debugger used to show debuggee information captured using the present invention.

### DETAILED DESCRIPTION OF THE INVENTION

A method, system and computer program product for capturing snapshots of a debuggee's state and debug data during a debug session is provided. More particularly, the method, system and computer program product of the present invention relates to capturing state and debug data of a debuggee at intervals during a debug session and allowing a software developer to view and annotate the captured state and debug data in a developer preferred manner.

A snapshot as used herein is a capture of information which is contained in or made available by the debugger at the time that a snapshot is “taken”. In the preferred embodiment, only the state and debug information pertaining to those entities that are being monitored in the debugger and presented or presentable to the developer for view through the debugger UI at the time that the snapshot is taken are captured by default and are available for subsequent review. Such entities can include the call stack, monitored expressions, registers, and storage contents. Optionally, the software developer may selectively include non-viewable information into a snapshot, e.g., the time and date of the debug session.

Snapshots are taken during a debug session at intervals or on occurrences determined by the software developer, whether, for example, by default of the snapshot tool or selectively by the developer, in order to capture debuggee state and debug information at any number of points during the debuggee's execution. Snapshots may be taken during a debug session, for example, arbitrarily at the will of the developer, at predetermined intervals chosen by the developer, or at the occurrence of an event(s). By taking more than one snapshot, the changes in the debuggee state and debug data may be viewed at different points/times in the execution of the debuggee. Thus, each snapshot taken in sequential order automatically reflects changes that take place in the debuggee state and debug information since a previous snapshot was taken.

Furthermore, snapshots act as a form of persistence of the debugging information presented or presentable to the developer in or through the debugger UI. In the preferred embodiment and as discussed in more detail below, the snapshots comprise a serialization of the objects corresponding to debuggee elements and which objects contain the state and debug information of the debuggee presented or presentable through the debugger UI—in essence, a “photograph” of the debugger UI by capture of the information that is used to generate as well as is presented through the debugger UI (although as described hereafter with respect to the preferred embodiment more like an “active” photograph). Consequently, a developer can easily revisit debug and state information captured in snapshots by “replaying” or individually viewing them by having such information presented to the developer through the debugger UI.

The persistence of the snapshots also permits the possibility for them to be captured by one developer and then examined by another. Such a scenario can especially play out where development is done on a team basis, involves components from other development groups, companies, etc., includes development done remotely or comprises developers having differing hardware, operating environment and/or debugging software configurations. So, when an error in code is discovered by a developer, rather than simply trying to describe the problem to the other relevant developer(s) and explaining the steps necessary to rediscover the problem, snapshots of the occurrence of the bug in a debug session can be created identifying the problem and the steps needed to discover and/or recreate it and transmitted to the other developer(s) for review by “replaying” the original developer's debug session.

Further, in the preferred embodiment, the developer may add annotations to each snapshot or a sequence of snapshots to indicate, for example, the developer's views on the debugging information presented in the snapshot(s).

Additionally, since in the preferred embodiment a snapshot, by default, contains only those entities which are currently displayed in the debugger UI, the software developer has control somewhat over exactly what gets saved as a snapshot by configuring the debugger UI with the information important or relevant to the developer. Thus, unlike typical core dumps and process logs, the developer can selectively choose the debugging information relevant or important to the developer for snapshot (thereby reducing “noise”) and then for later review. Further, the developer also has greater control over the amount of time and disk space required to capture this information.

The snapshot tool of the present invention, in simple terms, is a facility for capturing snapshots of a debuggee's state and debug data and for viewing and annotating the captured snapshots. The snapshot tool can be incorporated into a debugger (or any other software development tool for that matter) or be provided on an independent basis as a stand-alone tool. Further, the snapshot capturing viewing, and annotating aspects of the invention may be provided together or separately from each other or in any other combination. For example, the capturing, viewing and annotating aspects may be all together incorporated into a debugger or any other software development tool or be provided separately on an independent basis or in any other combination.

In a preferred embodiment, the snapshot tool is incorporated into a debugger. The inclusion of the snapshot tool in the debugger does not affect the normal operation of the debugger and/or the normal operation of the debuggee except perhaps that performance of the debugger may be impacted by virtue of the overhead of the snapshot tool functionality. While a debuggee needs to be started under debug control of a debugger for capture of the snapshots, the snapshot tool, whether incorporated into the debugger as in the preferred embodiment or as a stand-alone tool, does not require that the debuggee be started again under debug control of the debugger for viewing captured snapshots.

For example, a Snapshot Manager component may be provided in the debugger with which the debugger UI interfaces to get at the snapshots (serialized Model objects), annotate them, etc. To show a particular snapshot, the Snapshot Manager component simply hands the (debugger) UI a set of Model objects (i.e. the deserialized snapshot Model objects) and the UI may prime its views with the information contained therein. If the user cares to revert back to live debugging, the Snapshot Manager re-primes the (debugger) UI views with the information from the set of Model objects representing the live debuggee. In this manner, the UI goes through an API and avoids having intimate knowledge about the Model objects. Having such an API allows other tools to be written to access the snapshot objects. Other UIs may be used or tools may be used to analyze the state and debug data embodied in the snapshot objects.

Snapshot Tool Environment

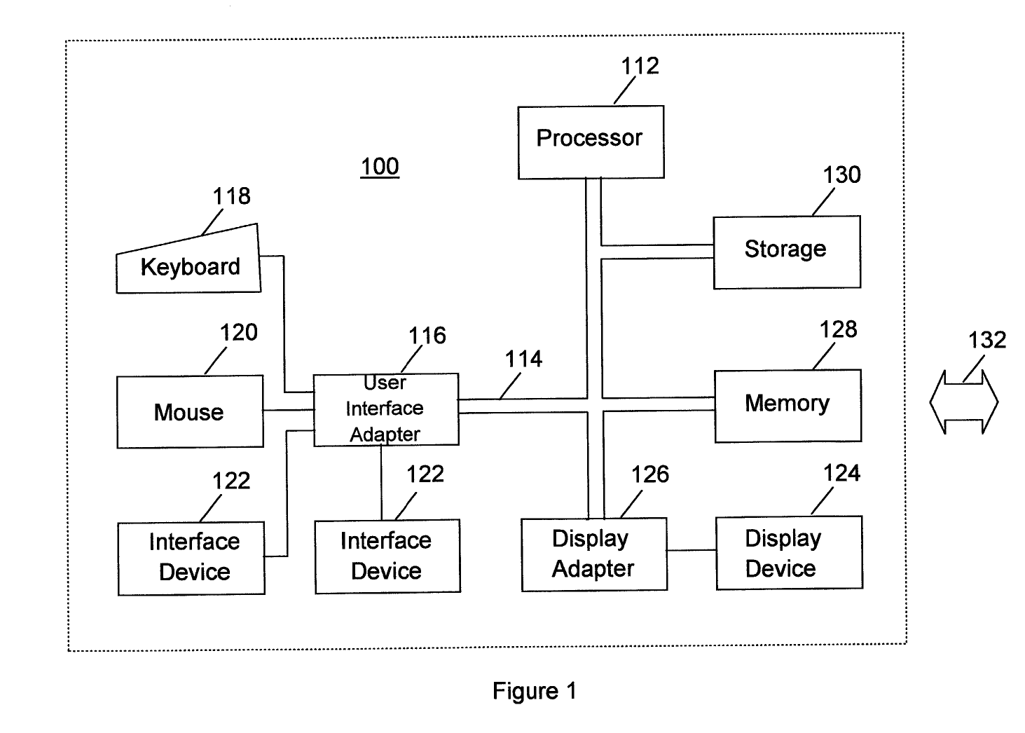

FIG. 1 illustrates a representative computer workstation hardware environment in which the present invention may be practiced. The environment of FIG. 1 comprises a representative single user computer workstation 100, such as a personal computer, including related peripheral devices. The workstation 100 includes a microprocessor 112 and a bus 114 employed to connect and enable communication between the microprocessor 112 and the components of the workstation 100 in accordance with known techniques. The workstation 100 typically includes a user interface adapter 116, which connects the microprocessor 112 via the bus 114 to one or more interface devices, such as a keyboard 118, mouse 120, and/or other interface devices 122, which can be any user interface device, such as a touch sensitive screen, digitized entry pad, etc. The bus 114 also connects a display device 124, such as an LCD screen or monitor, to the microprocessor 112 via a display adapter 126. The bus 114 also connects the microprocessor 112 to memory 128 and long-term storage 130 which can include a hard drive, diskette drive, tape drive, etc.

The workstation 100 may communicate with other computers or networks of computers, for example via a communications channel or modem 132. Alternatively, the workstation 100 may communicate using a wireless interface at 132, such as a CDPD (cellular digital packet data) card. The workstation 100 may be associated with such other computers in a local area network (LAN) or a wide area network (WAN), or the workstation 100 can be a client in a client/server arrangement with another computer, etc. All of these configurations, as well as the appropriate communications hardware and software, are known in the art.

Operation of the Snapshot Tool

In the preferred embodiment, the snapshot tool is a extension of a debugger and the description hereafter will discuss the snapshot tool of the present invention as integrated into and extended from a debugger. As previously stated, the snapshot tool need not be integrated into and/or extended from a debugger.

In the preferred embodiment, the snapshot tool is extra functionality incorporated into the debugger and the debugger UI. Code is incorporated into the debugger to provide the capturing, viewing, annotating, etc. of snapshots. Particularly, extra menu items or other types of command functionality are added to the debugger UI to selectively allow the developer to capture, view, annotate, etc. snapshots of the debug information presented or presentable to the developer through the debugger UI.

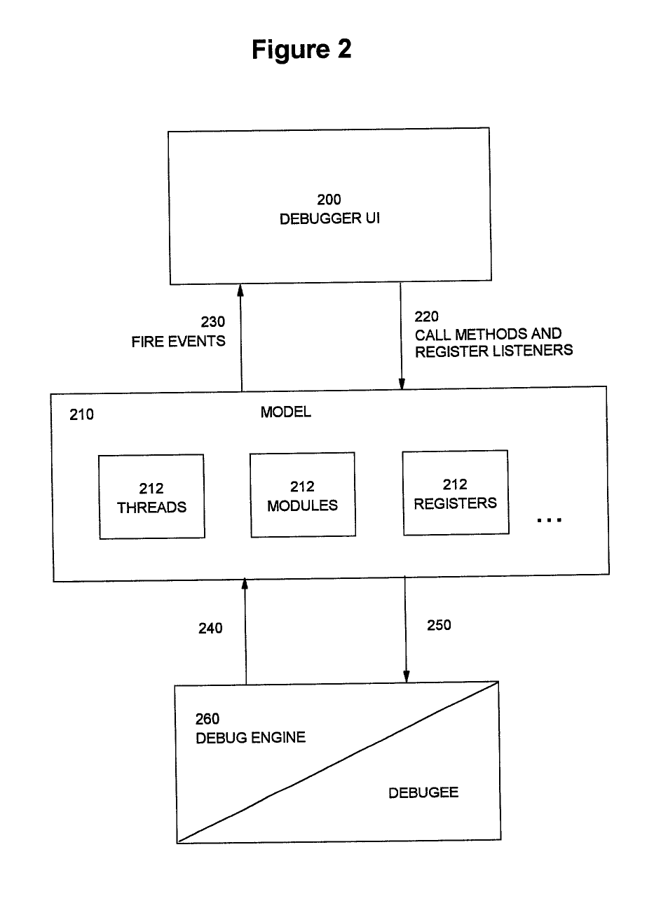

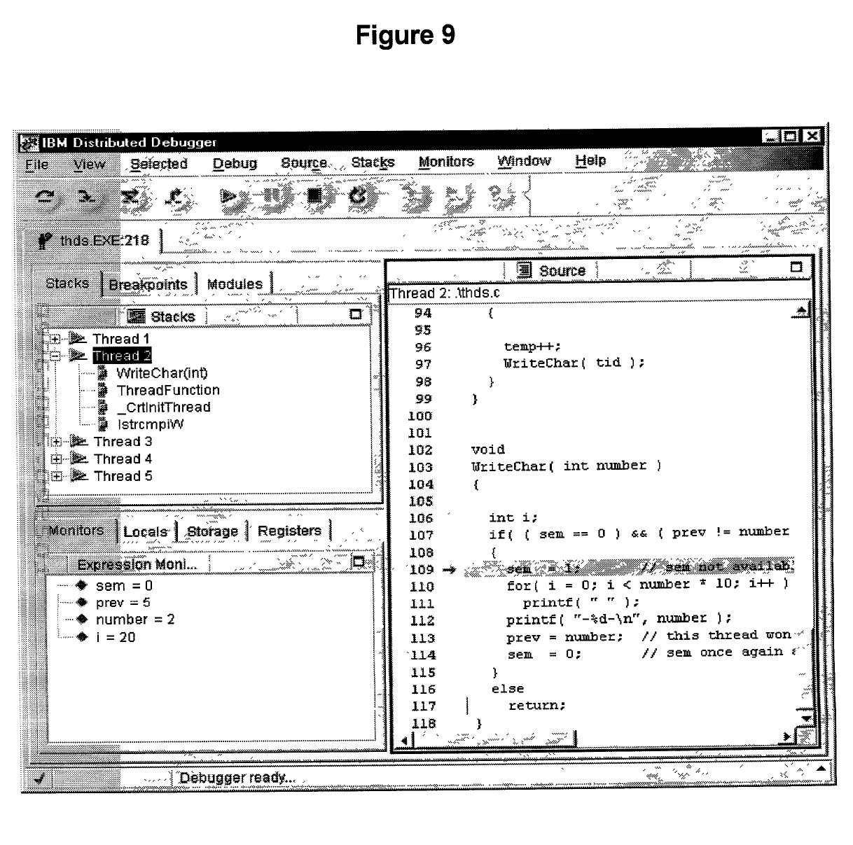

To facilitate the capture of snapshots, the debugger of the preferred embodiment is structured according to a model-view-controller paradigm. Referring to FIG. 2, a debugger UI 200, which may comprise one or more graphical views such as tabs or frames (see, e.g., FIGS. 9 to 11), sits on top of a set of classes that represent elements of a debuggee and which are instantiated to a set of objects for a particular debuggee during a debug session, collectively called herein the Model 210. The Model includes a complete representation of the state and debug information of the debuggee. When state and debug information of the debuggee is needed for display in the debugger UI, the debugger UI can obtain this information by calling methods 220 on objects in the Model that correspond to that debuggee state and debug information. For example, the Model may contain objects 212 which represent the debuggee's threads, register values, storage contents, call stack entries, etc. Similarly, the Model also allows the debugger UI to “drive” (usually in response to developer input) the debug session. For example, when a developer wants to set a breakpoint, evaluate an expression or let the debuggee run, there are methods in the Model that user interactions in the debugger UI can cause to make these things happen. Further, the Model uses an event-listener mechanism to inform the debugger UI when the debuggee's state and/or debug information has changed so that the relevant state and debug information presented in the debugger UI can be updated. The debugger UI registers 220 itself with certain or all Model objects as being interested in certain events and is subsequently notified whenever those events occur 230. For example, there is a “thread-added” event which may be fired (and heard by a registered listening debugger UI) when a new thread is created within the process being debugged.

In operation, the Model caches information sent to it 240 by a debug engine 260 (which may be remote in the network from the debugger UI or the Model itself) that interacts with the debuggee regarding the state and debug data of the debuggee and ensures that its view of the debuggee's state and debug data is consistent with that of the debug engine. In essence, the objects in the Model represent a kind of “virtual debug engine”/“virtual debuggee” which the debugger UI can use to populate its views and control the debug session. The Model uses an event delegation approach to inform the debugger UI when significant changes have occurred in the state and/or debug data of the debuggee. The debugger UI registers itself with the Model as a listener on certain events, typically pertaining to the debuggee, and is subsequently notified whenever those events occur.

Likewise, the Model allows the debuggee (via the debug engine) to be manipulated through the debugger UI (usually in response to developer input) by the call of Model methods on Model objects. The Model ensures that the appropriate requests are sent 250 to the debug engine and retrieves/processes the debug engine's reply in such a manner as to ensure consistency between the Model and the debug engine. For example, a request to set a breakpoint does not directly cause a breakpoint to be created in the Model. Rather, the breakpoint object in the Model will only be created once the debug engine has indicated to the Model that an actual breakpoint was successfully installed in the debuggee.

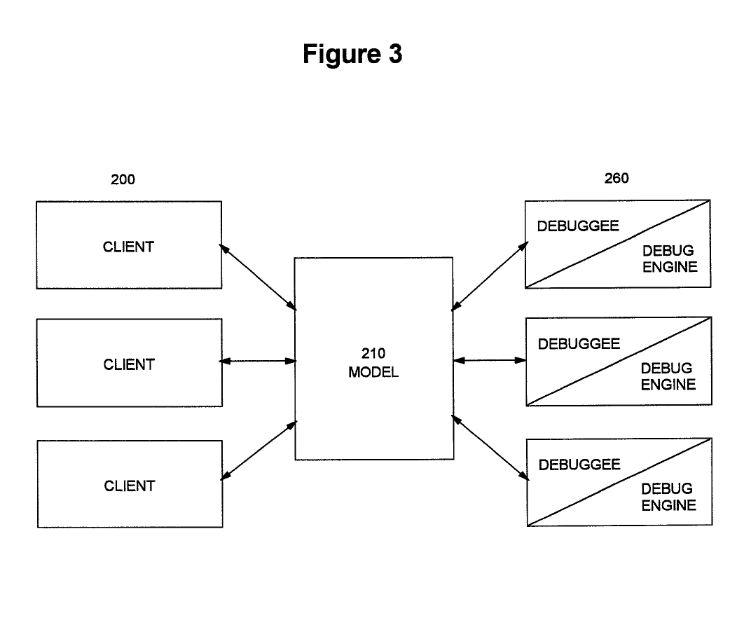

Furthermore, implementation of the Model as a set of classes permits several advantages. Significantly, referring to FIG. 3, the debugger UI may instantiate multiple “virtual debug engines”/“virtual debuggees” in the Model corresponding to multiple debug engines/debuggees 260 and thereby allow a developer to debug more than one program at a time within the same debug session and from the same debugger UI. The debuggees can all be running on the same machine as the debugger UI or they can be distributed across different machines in a network. Additionally, the debuggees may all be written in the same programming language, or there may be a mixture of programming languages. This accomplished by instantiating within the Model for every “virtual debug engine”/“virtual debuggee” a hierarchy of objects related to the process being debugged by that corresponding debug engine. The Model then takes care of all communications with the actual debug engines and ensures that the association between its “virtual debug engines” and the actual debug engines is maintained.

A further advantage of the Model being implemented as a set of classes is that one or more “clients” 200 (e.g. debugger graphical UIs, analysis tools, command-line debuggers, etc.) can access the same set of Model objects simultaneously, each one providing different views of the same debuggee and different ways of controlling the debug session. For example, one or more debugger UIs may access the Model objects providing different graphical views of the debuggee state and debug information. This is accomplished by permitting multiple listeners to be registered on any given object in the Model so that when a change or event occurs all listeners i.e. “clients” will be informed and can adjust their views, etc.

In short, the Model acts as a repository of information regarding the current state and debug data of a process being debugged. For example, there will be a Module object for every module (.exe or .dll) loaded in the process, a Debuggee Thread object for every thread in the process, as well as objects representing monitored variables, storage contents, register values, etc. When the debugger UI displays module, thread, monitored variables, storage contents, register values, etc. information regarding the debuggee to the software developer, it is obtaining that information by querying those corresponding objects in the Model. Whenever the actual state and/or debug data of the debuggee changes, the Model is updated to reflect the changes and events are fired to inform the debugger UI of the changes.

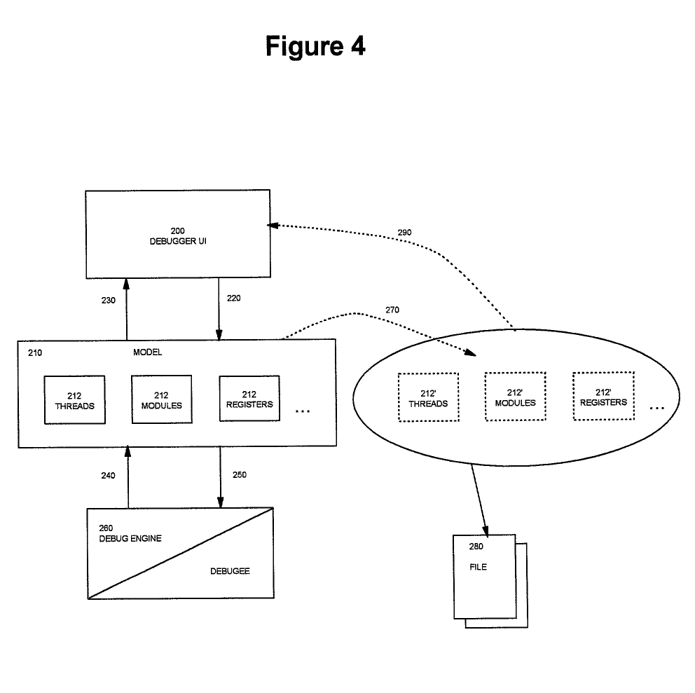

Referring to FIG. 4, a snapshot of the state and debug data of a debuggee at a certain point in time in the debug session is then merely a serialization 270 of the objects 212′ in the Model which represent that state and debug data and whose information are presented in the debugger UI. Optionally, state and debug information for the debuggee that is not presented in the debugger UI may also be selectively saved by serializing the appropriate objects corresponding to that information with the snapshot (not shown). Serialization is typically initiated selectively by the developer instructing/actioning the Model through the debugger UI (or through an independent snapshot tool should the invention be so implemented) to serialize the relevant Model objects. Alternatively, the serialization may be caused automatically on the occurrence of significant changes in the state and/or debug information of the debuggee, on the occurrence of specific event and/or at predetermined intervals. Furthermore, should there be multiple clients to the Model, the Model manages the serialization requests from such clients—serializing a set of objects for each snapshot requesting client. Similarly, where there are multiple debug engines being managed by a single client, the Model serializes the relevant objects depending on the view provided in the debugger UI or other snapshot configuration established by the developer.

To persist a snapshot, the serialized objects that represent the state and debug data of the debuggee at a certain point in time in the debug session (and that comprise a snapshot) are in the preferred embodiment written out to a file 280, along with any annotations and/or comments the software developer might care to add (which functionality is provided in the debugger/snapshot tool UI as described hereafter). Each new snapshot from a debug session can be added to the same file or a separate file can be generated for each snapshot. By serializing only those objects whose information is presented in the debugger UI (and optionally other objects corresponding to state and/or debug information not presented in the debugger UI) a snapshot is typically less expensive than a core dump which captures a complete image of a program's address space.

When the software developer wishes to view a snapshot that has been saved, it is simply a matter of deserializing 290 the relevant serialized Model objects and displaying them using the same debugger UI views (e.g. FIGS. 9 to 11) that are used to display “current” information. The UI deals with these deserialized Model objects in the same manner as the original (and other) Model objects—simply by displaying the contents of Model objects. By having the ability to view the snapshots in the same debugger UI used for debugging, the developer in a preferred embodiment is able to view all the information that is presented to the developer during the original debug session and may manipulate the graphical views of that information as in the original debug session.

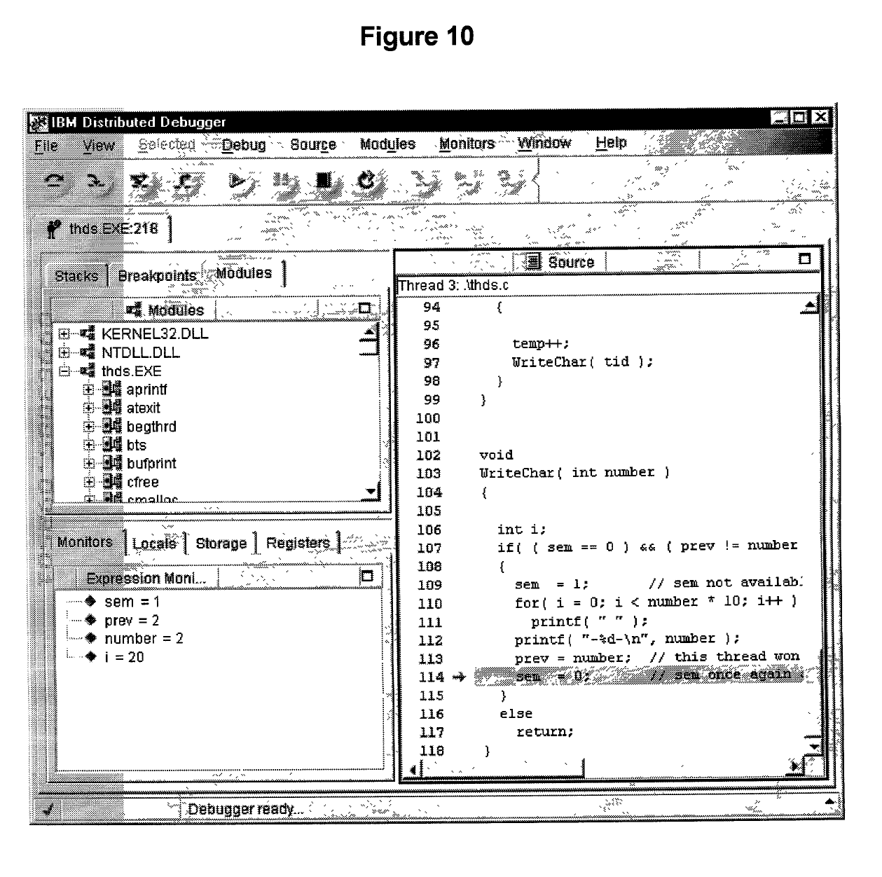

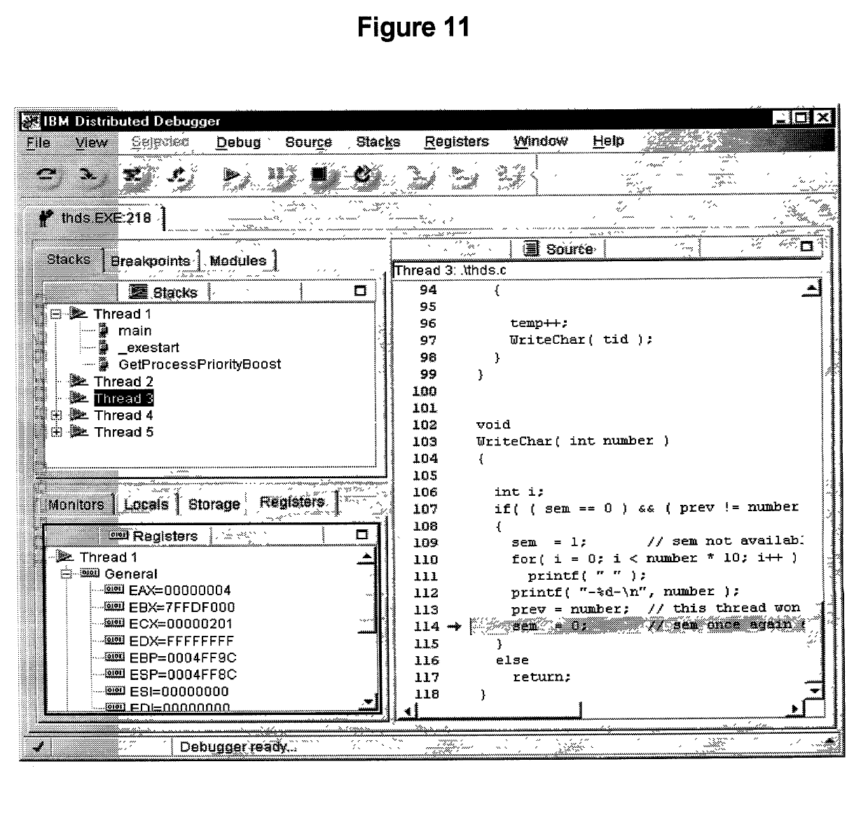

For example, referring to FIGS. 9 to 11, a debugger UI may provide a tabbed view where there are several “pages” of information which overlay each other. The snapshot may preserve such information on all the pages and allow the developer to view the information on each page as in the original debug session by, for instance, clicking on the tabs to view information hidden from sight initially. In FIG. 9, for example, a screenshot of a debugger UI is shown wherein the stack for thread 2 is shown and the values of some monitored expressions (bottom left pane) are shown when the application is at line 109 (which is highlighted in the right pane). As can be seen, tabs are provided for the user to see other state and debug information such as breakpoints, modules, registers, etc. A snapshot may be taken of this state and debug information, and the user may later review the information in this original debugger UI (including the ability to select other tabs). Referring to FIG. 10, the Modules tab has been selected to show the modules of the application as well the values of the monitored expressions at line 114 are shown. FIG. 11 shows another representative debugger UI showing state and debug information for thread 3 of the application. Snapshots of the debug and state information represented in these debugger UI screens may also be captured as snapshots for later review. A snapshot may then be more than merely a “photograph” of the debugger UI at the time of the snapshot, indeed more like an “active photograph”. Moreover, the deserialized Model objects may make the state and debug information available for processing by other tools. Instead of encapsulating the debuggee state and debug information merely as pixels, the state and debug information may be analyzed easily without excessive parsing and conversion.

In a preferred embodiment, the Model may be implemented in Sun Microsystems' Java™ language. Java is advantageous because the core Java application programming interface (API) provides for serialization and deserialization of objects. Special coding is not necessarily required. Moreover, implementation in Java may permit operating system platform independence, meaning that the debugger and snapshot tool may be used on any operating system platform supporting Java without having to port the debugger and snapshot tool to that platform.

Optionally, the debugger may be extended to include not only the snapshot facility of the present invention but also to allow for viewing of the process logs in combination with the snapshots. A software developer may then view not only the state and debug data of the debuggee at any given point in its execution (as snapshots reflect) but also may view a listing of the events that took place which resulted in that state and debug data as revealed by the process log.

While the preferred embodiment has been described in terms of serialization of Model objects, the invention may alternatively be implemented by capturing internal debugger information at the relevant moment(s) in time, wherein the information may be used to reconstruct the debugger UI in the form of the snapshots of the present invention. In particular, data structures and other program information of the debugger may be persisted at the relevant moment(s) in time to form a snapshot of the debuggee information presented or presentable to the developer through the debugger UI. The persisted snapshot of debugger data structures and other program information may then be supplied to the debugger UI to reconstruct the debuggee information presented or presentable to the developer when the snapshot was taken.

Further, the invention should not be considered limited to debuggers or tools having graphical user interfaces. Indeed, the present invention can equally be applied to capture snapshots of text-based and/or numeric user interfaces such as found in command-line debuggers or other tools.

Features of the Snapshot Tool

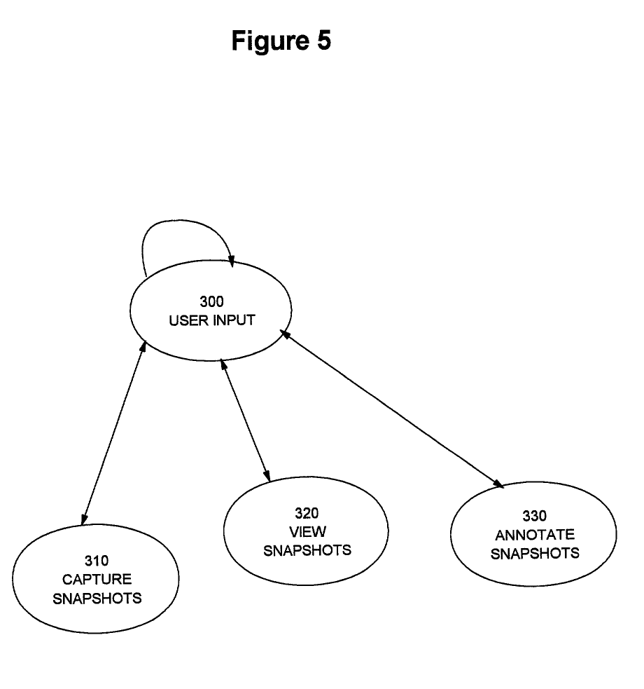

The snapshot tool of the present invention provides a number of snapshot features to the developer, typically through the snapshot tool UI. In a preferred embodiment, a debugger UI may be extended with menus or other user interaction features to allow the developer to take advantage of those snapshot features. Particularly, the extended debugger UI comprising the snapshot tool UI may allow the developer, via the menus and other user interaction features of the extended debugger UI, to selectively capture snapshots, view snapshots and annotate snapshots. Hereinafter, reference will be made to the snapshot tool features which in the preferred embodiment are integrated with the debugger features of the debugger UI. Referring to FIG. 5, the basic functional structure of the snapshot tool features of the present invention as reflected through the debugger/snapshot tool UI is shown. The snapshot tool may wait for developer input 300 and depending on the developer input, e.g., clicking on a menu item or a graphical user interface (GUI) push button, may activate the capture of snapshots 310, the viewing of snapshots 320 and/or annotating of snapshots 330.

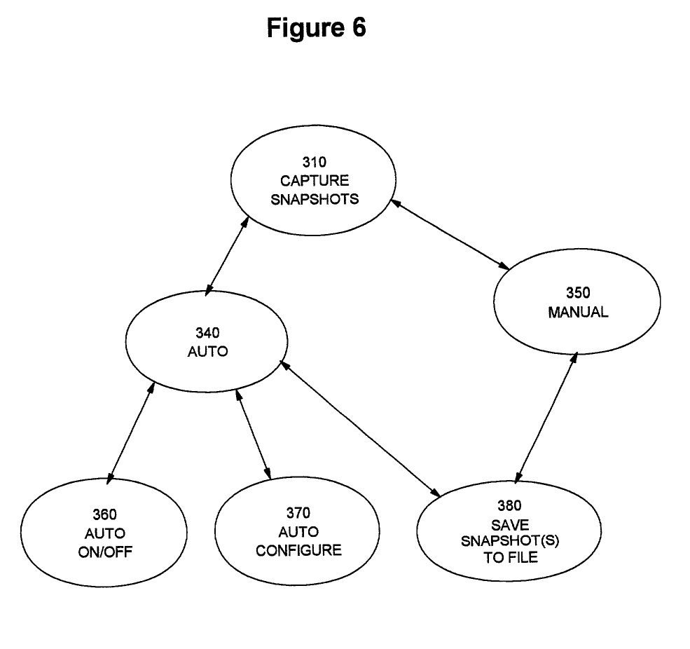

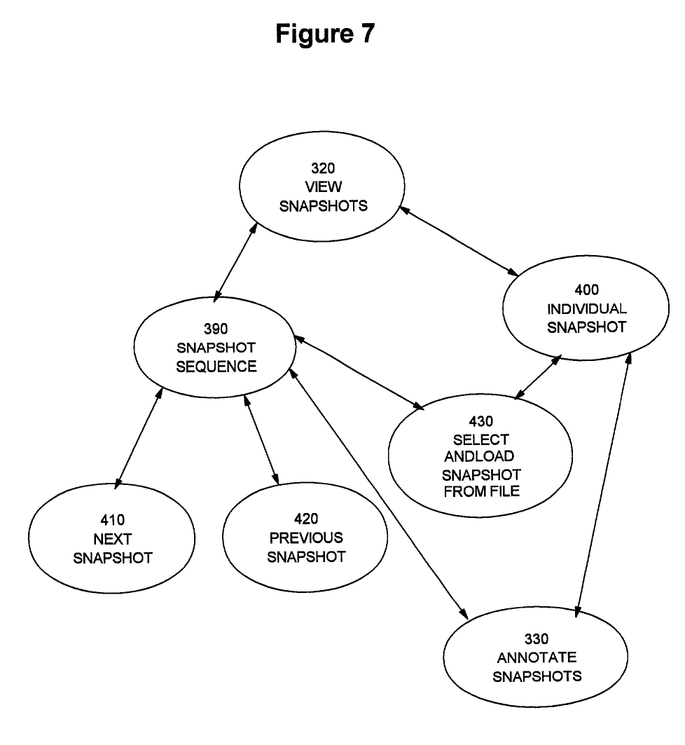

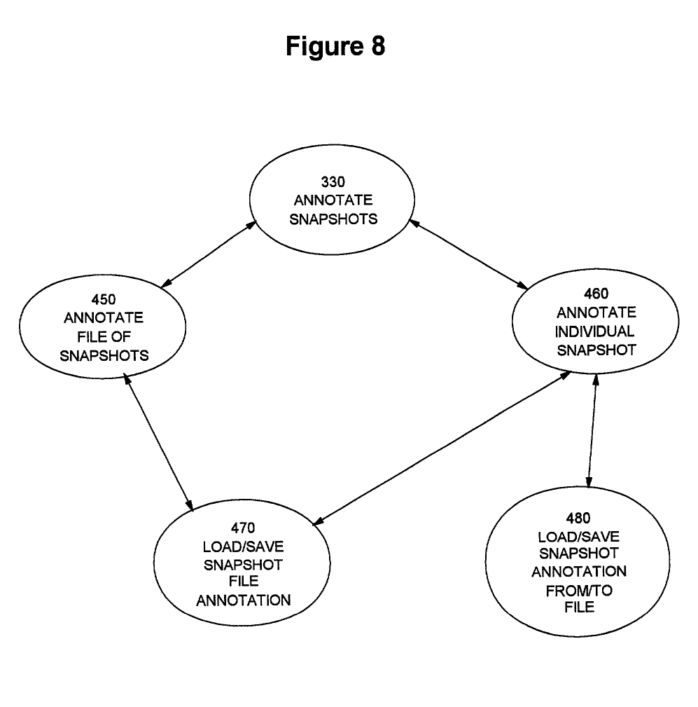

Referring to FIG. 6, a first feature of the snapshot tool is the ability to capture snapshots of a debuggee's state and debug information presented or presentable through the debugger UI at points during a debug session 310. In a preferred embodiment, two snapshot capturing modes are available to the developer—“auto” 340 and “manual” 350.

In “auto” mode, the snapshot tool automatically takes a snapshot of the debuggee's state and debug information presented or presentable through the debugger UI whenever it detects that a significant change has taken place in the state and/or debug data of the debuggee. In the preferred embodiment, such “auto” snapshot capturing functionality may be disabled by default, and the developer may selectively turn the auto mode on (e.g. from the default “off” position) or off 360 through the snapshot tool UI. A significant change is designated by the snapshot tool and may optionally be user-configurable 370. A significant change may include a change in the value of certain registers, the loading of a module, creation of a new thread in the debuggee process, etc. “Auto” mode may also be implemented so that a snapshot is taken at predetermined or user-configurable time periods or on the occurrence of predetermined or user-configurable events in the execution of the debuggee. In each case, the developer may be able to selectively engage through the snapshot tool UI the auto mode using any one or a combination of these criteria for capturing a snapshot automatically. In the “auto” mode, the Model will save off the serialized objects corresponding to the debuggee's state and debug data (i.e. take a new snapshot) whenever it detects that something significant has changed, at predetermined intervals and/or on the occurrences of certain events 380.

In “manual” mode, the software developer may be in full control regarding when snapshots are taken. In a preferred embodiment, a Save button and/or menu item are provided in the snapshot tool UI for the developer to selectively capture snapshots. When in “manual” mode, the Model saves off the serialized objects corresponding to the debuggee's state and debug information presented or presentable through the debugger UI when the developer makes an indication to do so, preferably by clicking on the Save button/menu item in the debugger UI 380.

In the preferred embodiment and in the case of both the “auto” and “manual” modes, the snapshot tool is provided such that snapshots are persisted to a file preferably stored on disk storage 380. In both modes, the developer using the snapshot tool is provided options to name the file and provide directory specifics for the file 380. In the case of the “manual” mode, the developer may selectively save the snapshots by means of, for example, a Save button and/or menu item to individual files for each snapshot or for addition to a file storing one or more snapshots. Similarly, in “auto” mode, the developer may configure the automatic saving of snapshots to save the snapshots to individual files corresponding to each snapshot or to add each snapshot to a file containing one or more snapshots. By using these snapshot tool features, a developer may persist to file(s) a sequence of snapshots from a debug session. While the preferred embodiment employs persistence to disk storage, the invention may equally be implemented using simply RAM storage or persistence to storage media other than disk storage.

Another feature of the snapshot tool is the ability to view the captured snapshots whether by “playing” them or selectively viewing captured snapshots. In the preferred embodiment of the present invention, such functionality is implemented by providing the developer in the snapshot tool UI a list of the snapshots that have been taken, either during the current debug session, or during previous debug sessions. At the top level, the developer will be able to see a list of files containing snapshots as well as the annotation(s) that was saved with the snapshot or sequence of snapshots in those files. By selecting one of the files listed, the developer will be able to view the sole snapshot in the file or view a sequence of or individual snapshots in a file containing two or more snapshots.

Accordingly, in a first aspect of this feature in a preferred embodiment, the snapshot tool may provide the developer the capability to view a sequence of snapshots 390 by moving backwards and forwards through the sequence of snapshots that have been saved to a file. By selectively moving to a next captured snapshot 410 or to a previous captured snapshot 420, a developer may view the state and debug information of the debuggee as it existed when each snapshot was taken. A facility may be provided that allows for the retrieval of the snapshots whether from the file containing captured snapshots (although, as indicated earlier, the present invention is not limited to a file and disk storage paradigm and may include using other means such as RAM and databases). In a preferred embodiment, a developer may load the snapshots by means of, for example, a Load button and/or menu item, the selection of which may trigger retrieval into memory of the snapshots from the file containing such snapshots 430. By default in the preferred embodiment, viewing of the sequence of snapshots from a file may start at the first snapshot. However, to facilitate easier viewing, the snapshot tool may provide functionality accessible through the snapshot tool UI to select and load a particular snapshot from the file of snapshots 430 and which then acts as the initial reference point for moving to a next or previous snapshot in the sequence of snapshots saved in the file. In particular, the selection of a file of snapshot(s) from the list described above may expose the sole snapshot or a list of individual snapshots contained in the file. The developer may then be able to select a particular snapshot (either the sole snapshot or from the sequence of snapshots) and view that snapshot as well as use that snapshot as an initial reference point for moving to previous and next snapshots. Furthermore, at any point in the “playing” of the sequence of snapshots, the developer may have the opportunity to selectively view and/or modify annotations to individual snapshots or the sequence of snapshots as stored in the file or to add new annotations to individual snapshots or the sequence of snapshots 330. The annotation functionality of the snapshot tool of the present invention is described in more detail hereafter.

According to a second aspect of the viewing feature in a preferred embodiment, the snapshot tool may provide the developer the capability to view individual snapshots 400. As described above with respect to viewing a sequence of snapshots, the snapshot tool provides functionality accessible through the snapshot tool UI to select and load a particular snapshot from the file of snapshots 430. In particular, the selection of a file of snapshot(s) from the list of snapshot files exposed through the snapshot tool UI described earlier exposes the sole snapshot or list of individual snapshots contained in the file. The developer may then select a particular snapshot (either the sole snapshot or from the sequence of snapshots) and view that snapshot. Furthermore, the developer may selectively view and/or modify annotations to the selected snapshot or the sequence of snapshots as stored in the file or to add new annotations to the selected snapshot or the sequence of snapshots 330. The annotation functionality of the snapshot tool of the present invention is described in more detail hereafter.

In the preferred embodiment, the same debugger UI that is used to display the “current” debuggee state and debug information may also be used to view/display the snapshots, thereby providing a consistent interface for viewing this information. For example, monitored expressions that were saved as part of a snapshot may be displayed in the exact same way that monitored expressions are normally displayed during a debug session. However, much of the debugger's inherent functionality may be disabled while viewing a snapshot because snapshots do not reflect the “current” state and debug data of the debuggee (where a debuggee is under debug control of the debugger at the time of viewing the snapshots) or an active debuggee at all if there is no debuggee under the control of the debugger. For example, while viewing a snapshot, it may not be possible to click on one of the threads that was saved in that snapshot and try to resume or suspend the thread. Of course, as soon as the software developer returns to debugging an active debuggee (if there is one—recall that viewing snapshots does not require an active debuggee), all of the normal debugger functionality may be available again and the debug session may continue as usual.

A further feature of the snapshot tool is the ability to annotate each snapshot taken or a sequence of snapshots with comments typically specific to the information presented in the snapshot and/or sequence of snapshots 330. In the preferred embodiment of the invention, a developer can add an annotation to each snapshot 460 to provide indications with respect to a snapshot for later review by the same developer or for the benefit of other developers. Similarly, the snapshot tool may also provide the ability to add comments to a sequence of snapshots typically saved as a file 450. Such comments typically explain the nature and content of the snapshot file for the later benefit of the developer or for other developers. If the software developer chooses not to manually add annotations to the snapshots or comments to a sequence of snapshots, the snapshot tool may automatically add a comment with some minimal or user-configurable information such as debuggee name, date/time stamp, etc. Support for annotating snapshots and snapshot files is intended primarily for those situations in which the software developer wants to save the snapshots for future reference or wants to send the snapshots to a colleague; someone who simply wants to view snapshots that were taken during the current debug session is not likely going to take advantage of this feature.

The person of ordinary skill in the art will readily recognize that there are a number of other features, not described here, that may be available as part of the snapshot tool including mechanisms for configuring snapshot capturing and viewing, establishing developer preferences, etc.

If the debugger UI is used to view the snapshots, the debugger may also provide, as described above: a) disabling non-applicable functionality while viewing a snapshot; b) browsing lists of snapshot files as well as lists of the individual snapshots within those files; and c) annotating the snapshots and snapshot files.

The detailed descriptions may have been presented in terms of program procedures executed on a computer or network of computers. These procedural descriptions and representations are the means used by those skilled in the art to most effectively convey the substance of their work to others skilled in the art. They may be implemented in hardware or software, or a combination of the two.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or similar devices.

Each step of the method may be executed on any general computer, such as a mainframe computer, personal computer or the like and pursuant to one or more, or a part of one or more, program modules or objects generated from any programming language, such as C++, Java, Fortran or the like. And still further, each step, or a file or object or the like implementing each step, may be executed by special purpose hardware or a circuit module designed for that purpose.

In the case of diagrams depicted herein, they are provided by way of example. There may be variations to these diagrams or the steps (or operations) described herein without departing from the spirit of the invention. For instance, in certain cases, the steps may be performed in differing order, or steps may be added, deleted or modified. All of these variations are considered to comprise part of the present invention as recited in the appended claims.

While the description herein may refer to interactions with a user interface by way of, for example, computer mouse operation, it will be understood that within the present invention the software developer is provided with the ability to interact with these graphical representations by any known computer interface mechanisms, including without limitation pointing devices such as computer mouses or trackballs, joysticks, touch screen or light pen implementations or by voice recognition interaction with the computer system.

While the preferred embodiment of this invention has been implemented using Sun Microsystems' Java language, this invention need not be solely implemented using the Java language. It will be apparent to those skilled in the art that the invention may equally be implemented in other computer languages, such as object oriented languages like C++ and Smalltalk.

The invention is preferably implemented in a high level procedural or object-oriented programming language to communicate with a computer. However, the invention can be implemented in assembly or machine language, if desired. In any case, the language may be a compiled or interpreted language.

While aspects of the invention relate to certain computer language and other technological specifications (e.g. the Java Language Specification with respect to the Java computer language), it should be apparent that classes, objects, components and other such software and technological items referenced herein need not fully conform to the specification(s) defined therefor but rather may meet only some of the specification requirements. Moreover, the classes, objects, components and other such software and technological items referenced herein may be defined according to equivalent specification(s) other than as indicated herein that provides equivalent or similar functionality, constraints, etc. For example, instead of the Java language specification, classes, objects, components and other such software and technological items referenced herein may be defined according to Microsoft Corporation's ActiveX™ specification where applicable and appropriate.

The invention may be implemented as an article of manufacture comprising a computer usable medium having computer readable program code means therein for executing the method steps of the invention, a program storage device readable by a machine, tangibly embodying a program of instructions executable by a machine to perform the method steps of the invention, or a computer program product. Such an article of manufacture, program storage device or computer program product may include, but is not limited to, CD-ROMs, diskettes, tapes, hard drives, computer RAM or ROM and/or the electronic, magnetic, optical, biological or other similar embodiment of the program. Indeed, the article of manufacture, program storage device or computer program product may include any solid or fluid transmission medium, magnetic or optical, or the like, for storing or transmitting signals readable by a machine for controlling the operation of a general or special purpose programmable computer according to the method of the invention and/or to structure its components in accordance with a system of the invention.

The invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such a cellular telephone). The system may be specially constructed for the required purposes to perform, for example, the method steps of the invention or it may comprise one or more general purpose computers as selectively activated or reconfigured by a computer program in accordance with the teachings herein stored in the computer(s). The procedures presented herein are not inherently related to a particular computer system or other apparatus. The required structure for a variety of these systems will appear from the description given.

While this invention has been described in relation to preferred embodiments, it will be understood by those skilled in the art that changes in the details of construction, arrangement of parts, compositions, processes, structures and materials selection may be made without departing from the spirit and scope of this invention. Many modifications and variations are possible in light of the above teaching. Thus, it should be understood that the above described embodiments have been provided by way of example rather than as a limitation and that the specification and drawing(s) are, accordingly, to be regarded in an illustrative rather than a restrictive sense.

We claim:

1. A computer-implemented method for capturing one or more snapshots of a debuggee's state and debug data comprising the step of, at one or more points during a debug session of the debuggee, capturing information used to create a user interface of a debugger representing the debuggee's state and debug data as a snapshot for later usage.

2. The method of claim 1 wherein the debugger comprises objects corresponding to elements of the debuggee and which comprise the debuggee's state and debug data and wherein the step of capturing information as a snapshot comprises serializing the objects.

3. The method of claim 1 wherein the step of capturing information as a snapshot is executed selectively based upon user input.

4. The method of claim 1 further comprising the step of annotating one or more snapshots with a comment.

5. The method of claim 1 further comprising the step of viewing one or more snapshots through a user interface.

6. The method of claim 5 wherein the step of viewing comprises replaying one or more snapshots in the user interface by presenting a selected snapshot through the user interface and, if there are two or more snapshots, moving forward and backward through the snapshots and simultaneously presenting those snapshots through the user interface.

7. The method of claim 2 further comprising the step of viewing one or more snapshots through a user interface by deserializing the objects.

8. The method of claim 2 wherein only objects that contain state and debug information presented through the user interface of the debugger are serialized.

9. The method of claim 1 wherein the method is performed in a debugger.

10. A method for capturing a snapshot of a debuggee's state and debug data from a debugger, the debugger comprising objects containing the debuggee's state and debug data comprising the step of, during a debug session of the debuggee, capturing information used to create a debugger user interface representing the debuggee's state and debug data as the snapshot for later usage by serializing the objects.

11. A program storage device, tangibly embodying computer readable program code, for causing a computer to perform a computer-implemented method for capturing one or more snapshots of a debuggee's state and debug data comprising the step of, at one or more points during a debug session of the debuggee, capturing information used to create a user interface of a debugger representing the debuggee's state and debug data as a snapshot for later usage.

12. A computer program product for capturing one or more snapshots of a debuggee's state and debug data, the computer program product comprising computer readable code means to, at one or more points during a debug session of the debuggee, capture information used to create a user interface of a debugger representing the debuggee's state and debug data as a snapshot for later usage.

13. The computer program product of claim 12 wherein the debugger comprises objects corresponding to elements of the debuggee and which comprise the debuggee's state and debug data and wherein computer readable program means to capture information as a snapshot comprises computer readable program means to serialize the objects.

14. The computer program product of claim 12 wherein computer readable program means to capture information as a snapshot is executed selectively based upon user input.

15. The computer program product of claim 12 further comprising computer readable program means to annotate one or more snapshots with a comment.

16. The computer program product of claim 12 further comprising computer readable program means to view one or more snapshots through a user interface.

17. The computer program product of claim 16 wherein computer readable program means to view comprises computer readable program means to replay one or more snapshots in the user interface by presenting a selected snapshot through the user interface and, if there are two or more snapshots, moving forward and backward through the snapshots and simultaneously presenting those snapshots through the user interface.

18. The computer program product of claim 13 further comprising computer readable program means to view one or more snapshots through a user interface by deserializing the objects.

19. The computer program product of claim 12 incorporated into a debugger.

20. A computer program product for capturing a snapshot of a debuggee's state and debug data from a debugger, the debugger comprising objects containing the debuggee's state and debug data comprising a snapshot manager to, during a debug session of the debuggee, capture information used to create a debugger user interface representing the debuggee's state and debug data as the snapshot for later usage by serializing the objects.

21. A computer program product for capturing one or more snapshots of a debuggee's state and debug data, the computer program product comprising computer readable code means to, at one or more points during a debug session of the debuggee, capture information used to create a user interface of a debugger representing the debuggee's state and debug data as a snapshot for later usage.

22. A computer system for capturing snapshots of a debuggee's state and debug data comprising a means to, at one or more points during a debug session of the debuggee, capture information used to create a user interface of a debugger representing the debuggee's state and debug data as a snapshot for later usage.

23. A computer system for capturing one or more snapshots of a debuggee's state and debug data, the computer system comprising a snapshot manager to, at one or more points during a debug session of the debuggee, capture information used to create a user interface of a debugger representing the debuggee's state and debug data as a snapshot for later usage.
